(19) United States
(12) Patent Application Publication
(10) Pub. No.: US 2017/0270811 A1
(43) Pub. Date: Sep. 21, 2017

(54) LESSON PLAN PRESENTATION

(71) Applicant: International Business Machines Corporation, Armonk, NY (US)

(72) Inventors: Gerald D. Colar, Smyrna, GA (US); Melanie R. Diggs, Mableton, GA (US); Terrence E. White, Cottage Grove, MN (US)

(21) Appl. No.: 15/070,007

(22) Filed: Mar. 15, 2016

(51) Int. Cl. G09B 7/04

(52) U.S. Cl. CPC G09B 7/04

(57) ABSTRACT

A computer-implemented method includes identifying a user interface. The method includes identifying a lesson plan. The lesson plan includes a plurality of questions, each of the plurality of questions having associated therewith a correct answer. The method includes receiving an access request for the user interface. The method includes presenting, via the user interface, one of the plurality of questions. The method includes receiving an answer via the user interface. The method is responsive to the answer meeting one or more correctness criteria. The method includes granting the access request. A corresponding computer program product and computer system are also disclosed.

### BACKGROUND

The present invention relates generally to the field of educational questioning software, and more particularly to lesson plan presentation in the context of self-paced questioning systems.

Educational software for teaching or self-learning software may include coursework, assessments, and reference materials, as well as interactive systems that present users with questions on a topic of study, according to a lesson plan. Educational questioning software may be self-paced such that a user determines when he or she utilizes the educational software as opposed to other features of the computing device. Users of self-paced systems face challenges in completing self-learning questions in a diligent manner.

### SUMMARY

A computer-implemented method includes identifying a user interface. The method includes identifying a lesson plan. The lesson plan includes a plurality of questions, each of the plurality of questions having associated therewith a correct answer. The method includes receiving an access request for the user interface. The method includes presenting, via the user interface, one of the plurality of questions. The method includes receiving an answer via the user interface. The method is responsive to the answer meeting one or more correctness criteria. The method includes granting the access request. A corresponding computer program product and computer system are also disclosed.

### BRIEF DESCRIPTION OF THE DRAWINGS

FIG. 1 is a block diagram of an operational environment suitable for operation of a lesson plan presenting program, in accordance with at least one embodiment of the present invention.

FIG. 2 is a flowchart depicting operational steps for a lesson plan presenting program in accordance with at least one embodiment of the present invention.

FIG. 3 is a flowchart depicting operational steps for a lesson plan presenting program for presenting educational material in accordance with at least one embodiment of the present invention.

FIG. 4 is a block diagram of components of an operational apparatus suitable for executing a lesson plan presenting program, in accordance with at least one embodiment of the present invention.

### DETAILED DESCRIPTION

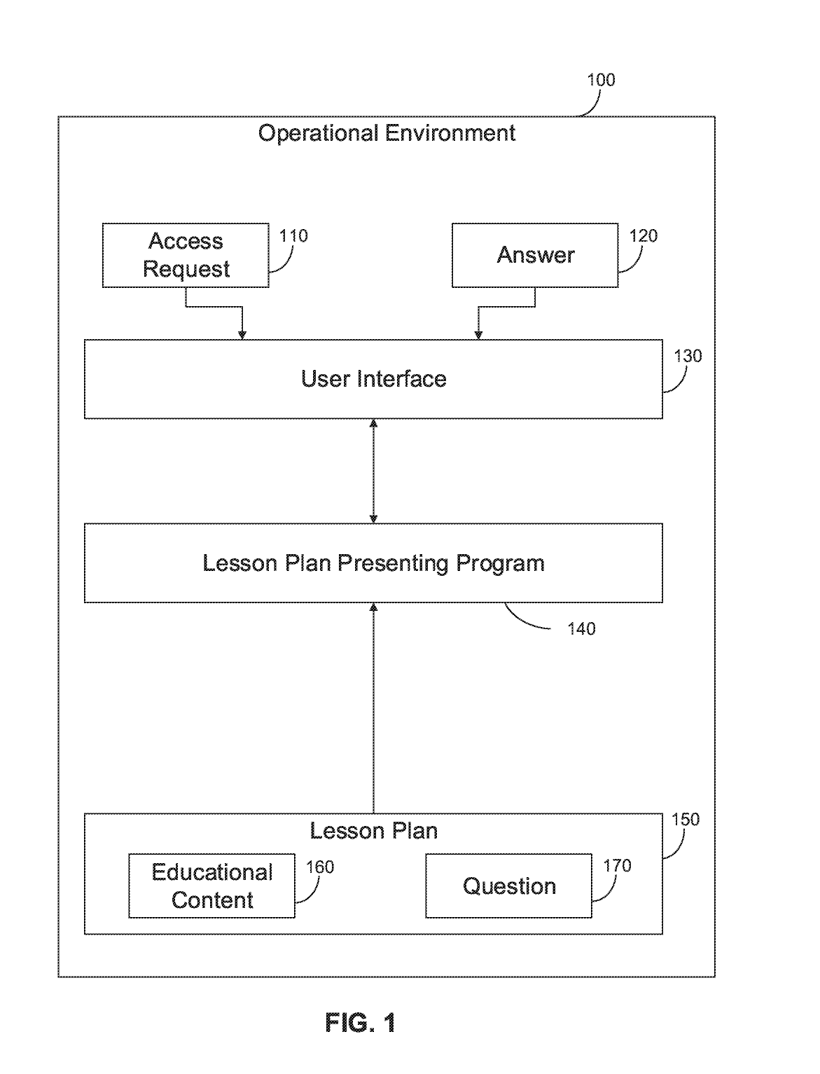

Referring now to the invention in more detail, FIG. 1 is a block diagram displaying an exemplary operational environment suitable for operation of at least one embodiment of the invention. An operational environment 100 includes an access request 110, an answer 120, a user interface 130, a lesson plan presenting program 140, and a lesson plan 150, which includes an educational content 160 and a question 170, all in mutual communication and interconnected via the operational environment 100. The operational environment 100 may be a cloud-based, virtual, or distributed environment or a remote environment on defined server hardware, or, more generally, the operational environment 100 may be any type of environment suitable for access by the user interface 130 of the lesson plan presenting program 140.

The user interface 130 is a space where interactions between a user and a computing device occur. The computing device may be a mobile device, laptop computer, desktop computer, or general computing device. For example, the user interface 130 may be a touchscreen on a mobile device. The user interface 130 may include an interface system selected from a group consisting of: a touchscreen, a non-touch sensitive display, one or more mechanical buttons, one or more capacitive buttons, a keyboard, a soft keyboard, a handwriting interface, an external human interface device, a global positioning system receiver, a camera, a microphone, a speaker, a light emitting device, and a light sensor. The interface system includes any way by which the computing device is able to receive input and/or display the question 170 or the educational content 160.

For example, in embodiments where the interface system includes a touchscreen, a mechanical button, a capacitive button, a keyboard, and/or a soft keyboard the computing device is able to receive input responsive to a user touching a particular portion of the computing device. The computing device may also be responsive to various properties of touch, including sensing differences in touch pressure, the presence of multiple touches, touch motions or gestures, and sequences of touches. In embodiments where the interface system includes a non-touch sensitive display, such as a display enabled to understand eye movement or voice commands. In such an embodiment, the computing device may receive input responsive to blinking, eye movement, or sound. Such an embodiment may include a camera, a microphone, and/or a speaker as a part of the interface system. In embodiments where the interface system includes a handwriting interface, the computing device may receive input responsive to a user writing words in a natural language, such as English, and the computing device identifying what words were written. In embodiment where the interface system includes an external human interface device, the computing device may respond to input from a remote source, such as a joystick, or another computing device.

In some embodiments, the user interface 130 may receive geographical information as input from an onboard global positioning system receiver. For example, a particular education lesson plan may include tracking a user's movement, such as directing the user to follow a particular path. In such an embodiment, the user interface 130 receives input from the user via the global positioning system receiver, as the user travels. In embodiments where the interface system includes a light emitting device, the user interface 130 may display the question 170 or the educational content 160 via the light emitting device. The light emitting device may be within an interface system including the touchscreen, the non-touch sensitive display, and/or the speaker. In embodiments where the interface system includes a light sensor the user interface 130 may receive input responsive to a user changing how much light the light sensor is exposed to, such as by tapping in Morse code.

The access request 110 may be understood as an attempt by a user to use a particular function of the computing device. For example, the access request 110 may be powering on the computing device. The access request 110 may be an attempt to open a particular website or social media application. The access request 110 may be time-sensitive. For example, it may be predetermined that any attempt to access a particular website after 10:00 pm is the access request 110 whereas attempts earlier in the day are defined not to be the access request 110. A user may input the access request 110 to the lesson plan presenting program 140 via the user interface 130.

The lesson plan 150 may be understood as a schedule for learning or practicing a particular subject matter area. The lesson plan 150 may be for a particular school subject, such as math or science, a plan to learn a foreign language, or a plan to learn a particular skill such knitting. The lesson plan 150 includes the educational content 160 and the question 170. The educational content 160 is any educational material that can be presented via the user interface 130. The educational content 160 may be in a medium selected from a group consisting of: video content, image content, diagram content, audio content, and text content. The question 170 is a question expressed in a natural language, such as English, that may be presented via the user interface 130. A user may answer the question 170 via the user interface 130 by inputting the answer 120. The question 170 is associated with a correct answer and correctness criteria. For example, the question 170 may be “what color is the sky?” to which the correct answer is “blue.” Correctness criteria may be for the answer 120 to be the correct answer. Correctness criteria may also be for the answer 120 to have been inputted via the user interface 130 within a predetermined timeframe. For example, correctness criteria may include producing a sound, such as a C-major scale or a word in a foreign language. Correctness criteria may include drawing a picture. Correctness criteria may include writing a free response answer.

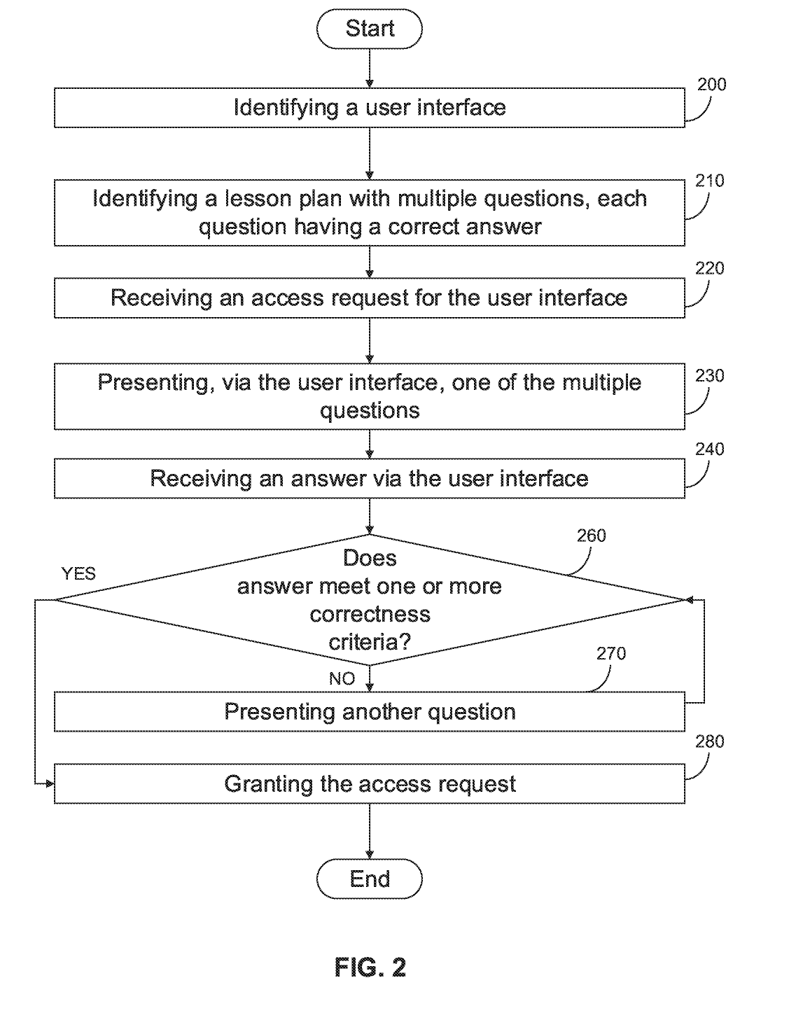

FIG. 2 is a flowchart depicting the operational steps of the lesson plan presenting program 140, executing within the operational environment 100 of FIG. 1, in accordance with an embodiment of the present invention.

At step 200, the lesson plan presenting program 140 identifies the user interface 130. Identifying may include a user explicitly calling the lesson plan presenting program 140 from a command line interface using a reference to the user interface 130 as an argument. Alternatively, receiving may include automated calls to the lesson plan presenting program 140, for example, from an integrated development environment or as part of a lesson plan presenting program management system.

At step 210, the lesson plan presenting program 140 identifies the lesson plan 150, which includes the educational content 160 and the question 170. The lesson plan 150 may include more than one education content items and more than one question. Each question included in the lesson plan 150 is associated with a correct answer.

At step 220, the lesson plan presenting program 140 receives the access request 110 via the user interface 130.

At step 230, the lesson plan presenting program 140 presents the question 170 via the user interface 130. Presenting may include displaying the question 170 via a user interface display. Presenting may include emitting the question 170 from a microphone. Presenting may include overriding the access request 110 such that the access request 110 is denied or temporarily denied. Presenting may include interrupting the access request 110 such that the access request 110 cannot be granted until a correct answer is inputted to the lesson plan presenting program 140 via the user interface 130.

In some embodiments, the lesson plan presenting program 140 may create an answer history. The answer history may be based on previous responses to previous questions that were posed by the lesson plan presenting program 140. The lesson plan presenting program 140 may catalog and organize which questions a user answered correctly and incorrectly via the answer history. For example, the answer history may include information that the user answers questions about a first topic correctly 95% of the time, but only answers questions about a second topic correctly 50% of the time. The lesson plan presenting program 140 may select which question within the lesson plan 150 to present based on the answer history. For example, the lesson plan presenting program 140 may preferentially select a question that addresses the second topic, because the user has a history of answering questions from that topic incorrectly. In some embodiments, the lesson plan 150 includes a question bank with questions such as the question 170. Each question within the question bank may have properties associated with it, such as topics, sub-topics, or difficulty. The lesson plan 150 may have a predetermined ordering for the presentation of questions within the question bank. In such an embodiment, the lesson plan presenting program 140 may update the ordering for the presentation of question within the question bank based on the answer history and the properties associated with each question. In other embodiments, the lesson plan 150 may randomly present questions from the question bank. In such embodiments, the lesson plan presenting program 140 may begin preferentially selecting questions from the question bank based on the answer history and the properties associated with each question. The lesson plan presenting program 140 may begin to preferentially select questions from the question bank after a predetermined number of questions are answered incorrectly. For example, the lesson plan presenting program 140 may randomly present questions until three are answered correctly. After three questions are answered incorrectly, the lesson plan presenting program 140 may select a question with a similar topic or sub-topic as the questions answered incorrectly.

At step 240, the lesson plan presenting program 140 receives the answer 120 via the user interface 130.

At step 260, the lesson plan presenting program 140 determines whether the answer 120 meets the correctness criteria for the question 170. The correctness criteria may be that the answer 120 is the correct answer. The correctness criteria may be that the answer 120 was inputted within a particular timeframe.

If yes, the answer 120 does meet the correctness criteria for the question 170, the lesson plan presenting program 140 proceeds to step 280. At step 280, the lesson plan presenting program 140 grants the access request 110. Granting the access request 110 may mean fulfilling the access request 110. For example, if the access request 110 was to access a particular social media application, granting the access request 110 may mean opening the particular social media application. In other embodiments, such as where the access request 110 was turning on the computing device, granting the access request 110 may be allowing the user to utilize all features of the computing device uninterrupted.

If no, the answer 120 does not meet the correctness criteria for the question 170, the lesson plan presenting program 140 proceeds to step 270. At step 270, the lesson plan presenting program 140 presents another question, similar but not the same as the question 170, via the user interface 130. In some embodiments, the lesson plan presenting program 140 identifies a wait-timer. The wait-timer may be associated with a predetermined amount of time. The lesson plan presenting program 140 may wait a predetermined amount of time before presenting another question. In some embodiments, the lesson plan presenting program 140 will be responsive to several answer attempt inputs and only present another question after waiting the predetermined amount of time. The wait-timer may be initiated after the question 170 is presented. In some embodiments, the lesson plan presenting program 140 may present another question after waiting the predetermined amount of time. In such an embodiment, the lesson plan presenting program 140 may present another question even if a user has not directly inputted an answer. In such an embodiment, the lesson plan presenting program 140 may identify a lack of input from a user as an answer 120 that does not meet the correctness criteria, similar to leaving a question blank.

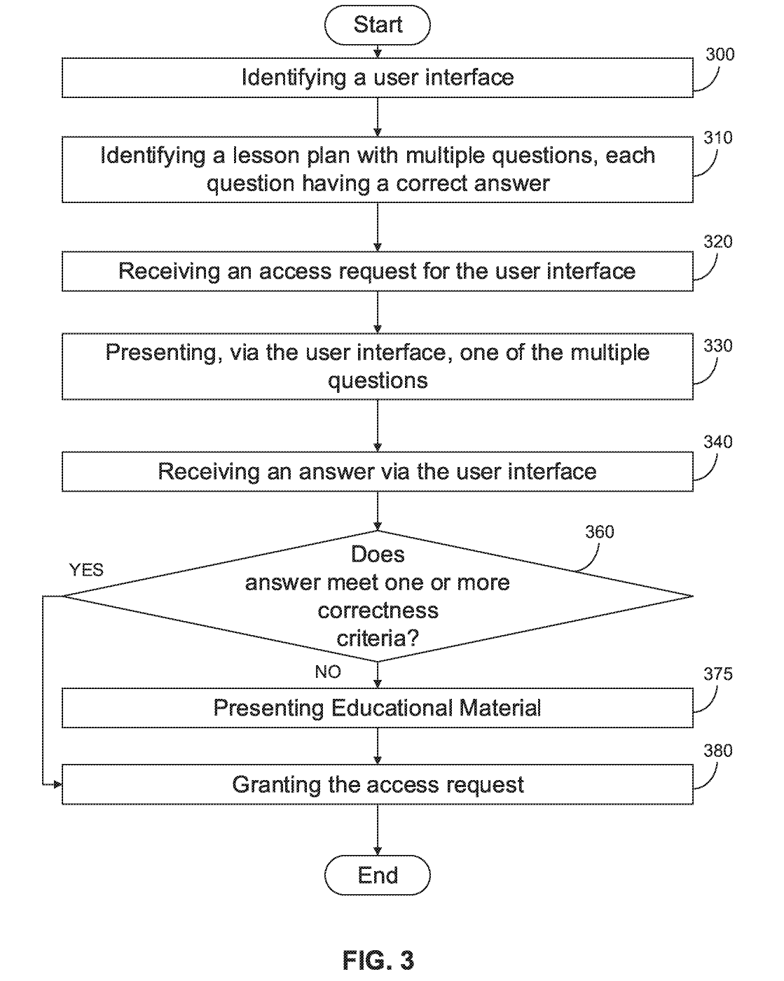

FIG. 3 is a flowchart depicting operational steps for the lesson plan presenting program 140 for presenting educational material in accordance with at least one embodiment of the present invention.

The lesson plan presenting program 140 performs step 300, step 310, step 320, step 330, step 340, step 360, and step 380 in a manner similar to step 200, step 210, step 220, step 230, step 240, step 260, and step 280, respectively.

If, at step 360 the lesson plan presenting program 140 determines no, the answer 120 does not meet the correctness criteria for the question 170, the lesson plan presenting program 140 proceeds to step 375. At step 375 the lesson plan presenting program 140 presents the educational content 160, via the user interface 130. As the lesson plan presenting program 140 is presenting the educational content 160, the lesson plan presenting program 140 may continue to deny the access request 110.

In some embodiments, the lesson plan presenting program 140 may ask another question, such as or similar to the question 170, within the lesson plan 150 after presenting the educational content 160. In some embodiments, the lesson plan presenting program 140 may receive a predetermined number of incorrect answers before presenting the educational content 160. For example, the lesson plan presenting program 140 may give a user three tries to correctly answer a question before presenting the educational content 160.

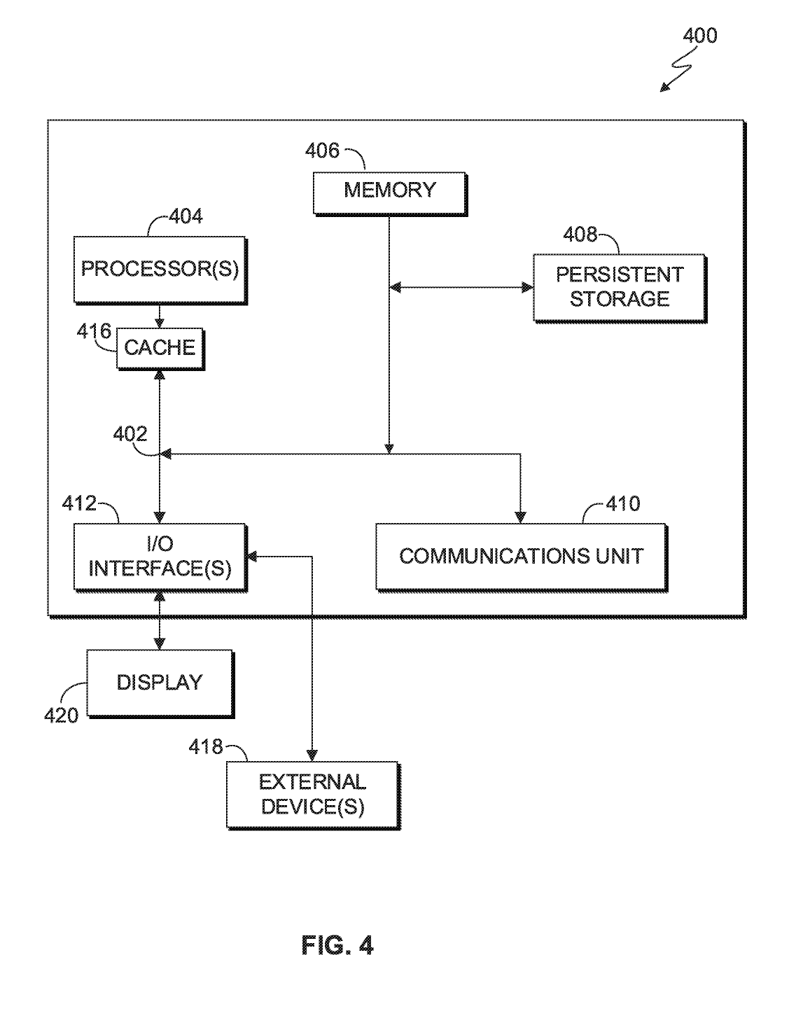

FIG. 4 is a block diagram depicting components of a computer 400 suitable for executing the lesson plan presenting program 140. FIG. 4 displays the computer 400, the one or more processor(s) 404 (including one or more computer processors), the communications fabric 402, the memory 406, the RAM 416, the cache 416, the persistent storage 408, the communications unit 410, the I/O interfaces 412, the display 420, and the external devices 418. It should be appreciated that FIG. 4 provides only an illustration of one embodiment and does not imply any limitations with regard to the environments in which different embodiments may be implemented. Many modifications to the depicted environment may be made.

As depicted, the computer 400 operates over a communications fabric 402, which provides communications between the cache 416, the computer processor(s) 404, the memory 406, the persistent storage 408, the communications unit 410, and the input/output (I/O) interface(s) 412. The communications fabric 402 may be implemented with any architecture suitable for passing data and/or control information between the processors 404 (e.g., microprocessors, communications processors, and network processors, etc.), the memory 406, the external devices 418, and any other hardware components within a system. For example, the communications fabric 402 may be implemented with one or more buses or a crossbar switch.

The memory 406 and persistent storage 408 are computer readable storage media. In the depicted embodiment, the memory 406 includes a random access memory (RAM). In general, the memory 406 may include any suitable volatile or non-volatile implementations of one or more computer readable storage media. The cache 416 is a fast memory that enhances the performance of computer processor(s) 404 by holding recently accessed data, and data near accessed data, from memory 406.

Program instructions for the lesson plan presenting program 140 may be stored in the persistent storage 408 or in memory 406, or more generally, any computer readable storage media, for execution by one or more of the respective computer processors 404 via the cache 416. The persistent storage 408 may include a magnetic hard disk drive. Alternatively, or in addition to a magnetic hard disk drive, the persistent storage 408 may include, a solid state hard disk drive, a semiconductor storage device, read-only memory (ROM), electronically erasable programmable read-only memory (EEPROM), flash memory, or any other computer readable storage media that is capable of storing program instructions or digital information.

The media used by the persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of the persistent storage 408.

The communications unit 410, in these examples, provides for communications with other data processing systems or devices. In these examples, the communications unit 410 may include one or more network interface cards. The communications unit 410 may provide communications through the use of either or both physical and wireless communications links. The lesson plan presenting program 140 may be downloaded to the persistent storage 408 through the communications unit 410. In the context of some embodiments of the present invention, the source of the various input data may be physically remote to the computer 400 such that the input data may be received and the output similarly transmitted via the communications unit 410.

The I/O interface(s) 412 allows for input and output of data with other devices that may operate in conjunction with the computer 400. For example, the I/O interface 412 may provide a connection to the external devices 418, which may include a keyboard, keypad, a touch screen, and/or some other suitable input devices. External devices 418 may also include portable computer readable storage media, for example, thumb drives, portable optical or magnetic disks, and memory cards. Software and data used to practice embodiments of the present invention may be stored on such portable computer readable storage media and may be loaded onto the persistent storage 408 via the I/O interface(s) 412. The I/O interface(s) 412 may similarly connect to a display 420. The display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
identifying a user interface;
identifying a lesson plan, said lesson plan comprising a plurality of questions, each of said plurality of questions having associated therewith a correct answer;
receiving an access request for said user interface;
presenting, via said user interface, one of said plurality of questions;
receiving an answer via said user interface; and
responsive to said answer meeting one or more correctness criteria, granting said access request.

2. The computer-implemented method of claim 1, further comprising:
responsive to said answer not meeting said one or more correctness criteria, presenting, via said user interface, another of said plurality of questions.

3. The computer-implemented method of claim 1, further comprising:
responsive to said answer not meeting one or more correctness criteria, presenting, via said user interface, educational content.

4. The computer-implemented method of claim 3, wherein said educational content comprises at least one medium selected from a group consisting of:
(a) video content;
(b) image content;
(c) diagram content;
(d) audio content; and
(e) text content.

5. The computer-implemented method of claim 2, further comprising:
identifying a wait-timer, said wait-timer being configured to wait a predetermined time; and
presenting, via said user interface, said another of said plurality of questions after at least said predetermined time.

6. The computer-implemented method of claim 1 wherein said user interface comprises at least one interface system selected from a group consisting of:
(a) a touchscreen;
(b) a non-touch sensitive display;
(c) one or more mechanical buttons;
(d) one or more capacitive buttons;
(e) a keyboard;
(f) a soft keyboard;
(g) handwriting interface;
(h) an external human interface device;
(i) a global positioning system receiver;
(j) a camera;
(k) a microphone;
(l) a speaker;
(m) a light emitting device; and
(n) a light sensor.

7. The computer-implemented method of claim 1, further comprising:
creating an answer history; and
selecting one of said plurality of questions based on said answer history.

8. A computer program product comprising:
one or more computer readable storage media and program instructions stored on said one or more computer readable storage media, said program instructions comprising instructions to:
identify a user interface;
identify a lesson plan, said lesson plan comprising a plurality of questions, each of said plurality of questions having associated therewith a correct answer;
receive an access request for said user interface;
present, via said user interface, one of said plurality of questions;
receive an answer via said user interface; and
responsive to said answer meeting one or more correctness criteria, grant said access request.

9. The computer program product of claim 8, further comprising instructions to:
responsive to said answer not meeting said one or more correctness criteria, present, via said user interface, another of said plurality of questions.

10. The computer program product of claim 8, further comprising instructions to:
responsive to said answer not meeting one or more correctness criteria, present, via said user interface, educational content.

11. The computer program product of claim 10, wherein said educational content comprises at least one medium selected from a group consisting of:
(a) video content;
(b) image content;
(c) diagram content;
(d) audio content; and
(e) text content.

12. The computer program product of claim 9, further comprising instructions to:
identify a wait-timer, said wait-timer being configured to wait a predetermined time; and
present via said user interface, said another of said plurality of questions after at least said predetermined time.

13. The computer program product of claim 8, wherein said user interface comprises at least one interface system selected from a group consisting of:
(a) a touchscreen;
(b) a non-touch sensitive display;
(c) one or more mechanical buttons;
(d) one or more capacitive buttons;
(e) a keyboard;
(f) a soft keyboard;
(g) handwriting interface;
(h) an external human interface device;
(i) a global positioning system receiver;
(j) a camera;
(k) a microphone;
(l) a speaker;
(m) a light emitting device; and
(n) a light sensor.

14. The computer program product of claim 8, further comprising instructions to:
create an answer history; and
select one of said plurality of questions based on said answer history.

15. A computer system comprising:
one or more computer processors;
one or more computer readable storage media;
computer program instructions; and
said computer program instructions being stored on said computer readable storage media for execution by at least one of said one or more processors, said computer program instructions comprising instructions to:
identify a user interface;
identify a lesson plan, said lesson plan comprising a plurality of questions, each of said plurality of questions having associated therewith a correct answer;
receive an access request for said user interface;
present, via said user interface, one of said plurality of questions;
receive an answer via said user interface; and
responsive to said answer meeting one or more correctness criteria, grant said access request.

16. The computer system of claim 15, further comprising instructions to:
responsive to said answer not meeting said one or more correctness criteria, present, via said user interface, another of said plurality of questions.

17. The computer system of claim 15, further comprising instructions to:
responsive to said answer not meeting one or more correctness criteria, present, via said user interface, educational content.

18. The computer system of claim 17, wherein said educational content comprises at least one medium selected from a group consisting of:
(a) video content;
(b) image content;
(c) diagram content;
(d) audio content; and
(e) text content.

19. The computer system of claim 17, wherein said user interface comprises at least one interface system selected from a group consisting of:
(a) a touchscreen;
(b) a non-touch sensitive display;
(c) one or more mechanical buttons;
(d) one or more capacitive buttons;
(e) a keyboard;
(f) a soft keyboard;
(g) handwriting interface;
(h) an external human interface device;
(i) a global positioning system receiver;
(j) a camera;
(k) a microphone;
(l) a speaker;
(m) a light emitting device; and
(n) a light sensor.

20. The computer system of claim 15, further comprising instructions to:
create an answer history; and
select one of said plurality of questions based on said answer history.
